(19) United States
(12) Patent Application Publication
(10) Pub. No.: US 2008/0102426 A1
(43) Pub. Date: May 1, 2008

(54) METHOD TO PREPARE EMERGENCY STAFF

(76) Inventors: James Frenchik, Anchorage, AK (US); Linda Smith, Anchorage, AK (US)

Correspondence Address: MICHAEL RIES, 318 PARKER PLACE, OSWEGO, IL, 60543, US

(21) Appl. No.: 11/924,617

(22) Filed: Oct. 26, 2007

Related U.S. Application Data
(60) Provisional application No. 60/854,955, filed on Oct. 27, 2006.

(51) Int. Cl. G09B 19/00

(52) U.S. Cl. 434/262

(57) ABSTRACT

The present invention is a method to teach emergency personal to be prepared when a disaster occurs. The present invention relates to a set of cards worn by a test victim to simulate real injures from a simulated disaster, emergency personal read the set of cards to make sure that they react and act appropriately to treat the simulated victim.

This application claims priority to U.S. Provisional Application 60/854,955 filed Oct. 27, 2006, the entire disclosure of which is incorporated by reference.

### TECHNICAL FIELD & BACKGROUND

The present invention generally relates to the field of preparing disaster teams. More specifically, the present invention relates to a set of cards worn by a test victim to simulate real injures from a simulated disaster.

The present invention is a set of cards worn around the neck of a fake victim. Each set has 6 pages that are stacked on each other so that the bottom of each page is able to be seen after all the pages are stacked. Once all 6 pages are stacked the bottom portion can be seen showing the instruction title on that card. The 6 pages are connected together so that they can be flipped through and turned over to present the next page.

In the present invention the entire first page or card must be read before beginning a drill. At each change of location the victim will flip to the next card. Card 1 is INSTRUCTIONS. Card 2 is ON SCENE. Card 3 is TRANSPORT. Card 4 is TRIAGE. Card 5 is TREATMENT UNIT. Card 6 is LAB/RADIOLOGY. Only the victim is allowed to flip to the next card. All heath care providers can look at the current card and all previous cards. Health care providers may not flip to the next card. The victim should look at the line on each card with the heading mental status/behavior and act accordingly as each card is flipped to the next.

The disaster preparedness method or Dynamic Patient Scenarios (“DPS”) card sets are more realistic than single, static, and unchanging patient scenarios cards. Use of this tool creates a more dynamic mass casualty situation during which a system must respond to a large number of constantly changing patient scenarios.

The card sets are designed to present progressively more information as the victim advances through the disaster response exercise. The initial scene and transport cards only provide enough information for the primary responder to make a rapid triage assessment and decision. Subsequent cards provide more detailed vital signs and physical exam findings. Field triage personnel learn to use limited information in making their triage assessments.

The cards are detailed, printed and laminated (heavy duty) for durability and decontamination survival.

The individual DPS card sets are gender and age neutral which allows easier utilization of the volunteers that show up for the exercise. Specific genders and age groups are available if needed such as children or pregnant women. DPS cards stress the importance of continuous victim re-assessment throughout the triage and disaster response process.

The DPS card sets illustrate the clinical progression of various conditions commonly associated with disasters such as: chemical/toxic exposures, multitrauma, burns, blast injuries, etc.

The use of DPS card sets will promote design and assessment of a more effective hospital patient tracking system. After triage to specific hospital disaster treatment units, the clinical status of some patients will change. Some patients will require a higher level of care and some may show improvement. These patients will then require movement to other treatment units and will need to be tracked during the transfer process.

Some patients will die. Patient death during disaster response will teach the providers the importance of realistic resource utilization during multicasualty response. These patients will then need to be transferred to the morgue and their transfer must be accurately tracked. A master key is available to assess clinical competency of diagnosis, treatment and disposition.

Each scenario card set consists of 6 laminated cards attached to each other at the top by two rings. The rings will be attached to a safe, break-away lanyard to be worn around the mock victim's neck. The victim will be given simple instructions on how to use the cards and how the patient is likely to behave at each stage of the evaluation before the exercise begins. The providers will be allowed to look at the current and all previous cards. The providers will not be allowed to look at any subsequent cards.

Card 1: Simple instructions to the victim and providers and an overall description of the victim's condition, behavior, and moulage.

Card 2: On scene: Description of the victim's on-scene status including mental status/behavior, peripheral pulses, respiratory effort, and obvious injuries. The detail here is conspicuously absent which will teach field triage officers not to rely on actual vital signs that are typically presented on the usual victim description cards.

Card 3: Transport: Updated and/or reassessment of the victim's status including mental status/behavior, peripheral pulses, respiratory effort, and obvious injuries.

Card 4: Hospital triage: Initial full set of vital signs, updated mental status/behavior, peripheral pulses, respiratory effort, and obvious injuries.

Card 5: Treatment unit: Updated vital signs, updated mental status/behavior, peripheral pulses, respiratory effort, and obvious injuries.

Card 6: Lab and radiology results when appropriate and “clinical hint” regarding potential diagnostic studies and treatments as well as what may be harmful to the patient.

Type of scenario: Refer to the DPS Order Form on the product page to to see what scenario types are available for rent or purchase. We have produced DPS card sets that represent commonly exercised scenario types such as CBRNE, blunt, and penetrating trauma injury patterns.

In addition to specific disaster related injury patterns, special needs victims such as (but not limited to) pediatrics, elderly, pregnant victims, etc. can be ordered to improve the value of the training experience.

Custom victim sets can be ordered and must be discussed with a DPRO representataive. Custom sets are more expensive due to the cost associated with development time, formatting, and printing. Custom victim sets are any injury pattern not present on the product order form.

Each set of DPSs are accompanied by a just-in-time training module with clinical pearls related to the types of injuries present. The training module is based on the most current literature and references are provided. Each DPS that represents a specific disaster related injury pattern will educate providers “real-time” and will have relevant clinical treatment hints at the end. For example, a DPS card set representing a victim with suspected blast lung injury (BLI) will provide clinical and diagnostic findings consistent with BLI. Additionally, the victim's condition will progress and deteriorate from Card#2 to Card#6. Finally, hints to avoid positive pressure ventilation will appear at the end of Card#6. Note: Just-In-Time Training Manuals will not be offered for blunt and penetrating trauma DPS sets. Caring for these victims does not require any additional specific training beyond Advanced Trauma Life Support (ATLS) or Basic Trauma Life Support (BTLS).

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an entire set of cards, in accordance with one embodiment of the present invention; and

FIG. 2 illustrates one page from the entire set of cards, in accordance with one embodiment of the present invention;

FIG. 3 illustrates one page from the entire set of cards, in accordance with one embodiment of the present invention;

FIG. 3a illustrates one page from the entire set of cards, in accordance with one embodiment of the present invention

FIG. 4 illustrates one page from the entire set of cards, in accordance with one embodiment of the present invention;

FIG. 5 illustrates one page from the entire set of cards, in accordance with one embodiment of the present invention;

FIG. 6 illustrates one page from the entire set of cards, in accordance with one embodiment of the present invention; and

FIG. 7 illustrates the set of cards on two victims, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

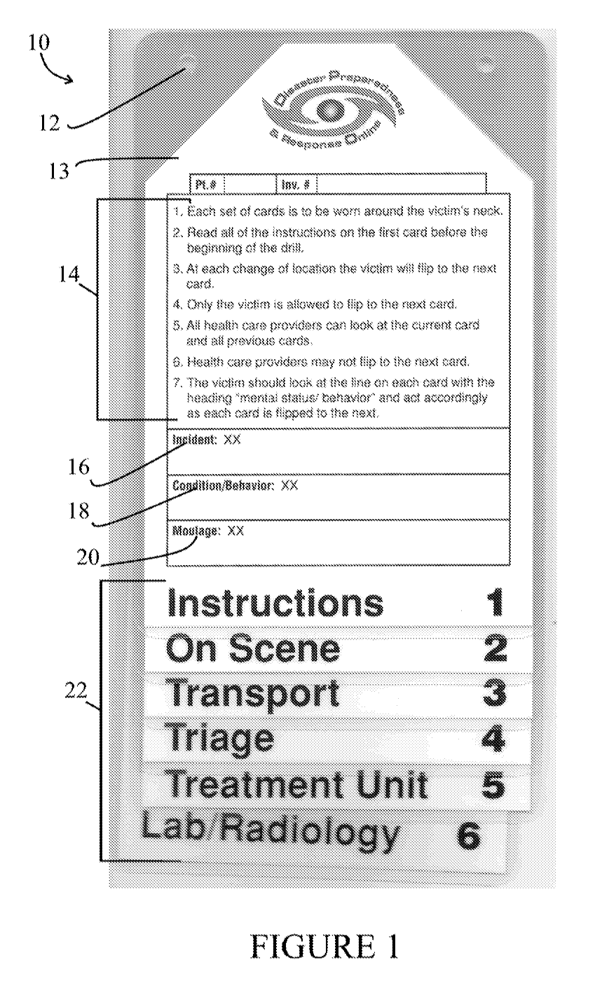

Referring now to FIG. 1, as in one embodiment of the present invention, illustrated is a disaster preparedness method 10 with connecting holes 12. Connecting holes 12 hold all the pages of the disaster preparedness method 10 together and can accept a necklace to allow the victim to hang the disaster preparedness method 10 from their neck. Connecting holes 12 may accept a ring to allow each page to be flipped over and placed behind the entire set of cards. A first page 13 labeled Instructions 1 is shown as the top page with an instructions box 14. Instructions box 14 may have the following: 1. Each set of cards is to be worn around the victim's neck; 2. Read all of the instructions on the first card before the beginning of the drill; 3. At each change of location the victim will flip to the next card; 4. Only the victim is allowed to flip to the next card; 5. All health care providers can look at the current card and all previous cards; 6. Health care providers may not flip to the next card; 7. The victim should look at the line on each card with the heading “mental status/behavior” and act accordingly as each card is flipped to the next.

In FIG. 1, as in one embodiment of the present invention, shown are incident box 16, condition/behavior box 18 and moulage box 20. Incident box 16 may have the particular disaster that is being simulated. Condition/behavior box 18 may have the victim's simulated conduct and behavior to be performed. Moulage box 20 may have the victim's fake injuries listed. Location of the victim and instructions 22 are all at the bottom of the set of cards and are purposely nested and offset to allow a user to see all the locations and the instructions on top when viewing the entire set. The nested and offset design helps the victim to keep the heath care provider viewing only the present page and any previous pages without viewing the remaining pages.

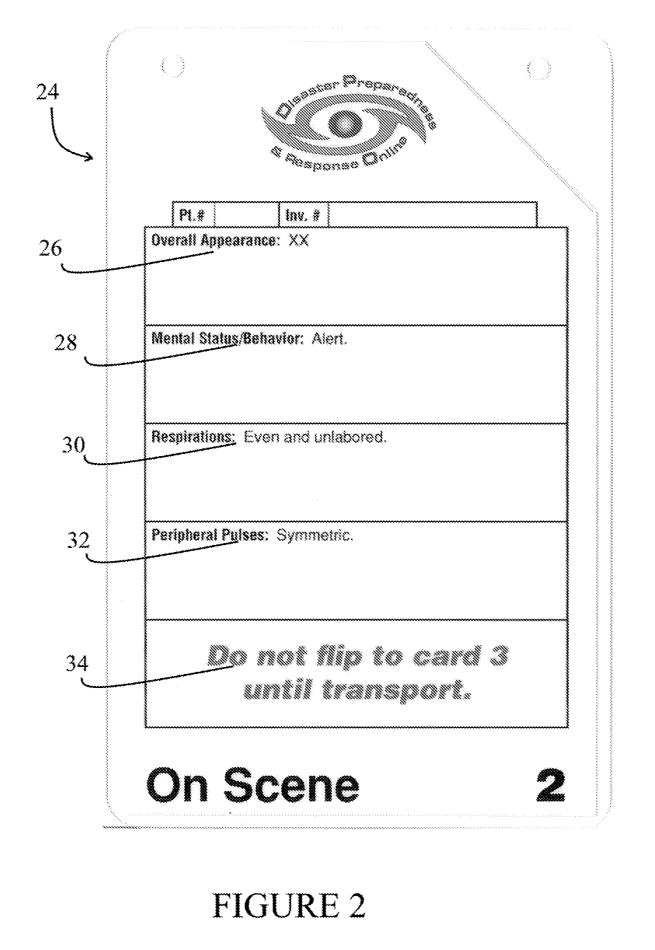

Referring to FIG. 2, as in one embodiment of the present invention, a second page 24 labeled On Scene 2 is shown as the second page with an overall appearance box 26. Shown are mental status/behavior box or field 28 with a note for example “alert”, Respirations box or filed 30 with a note of for example “even and unlabored” and Peripheral Pulses box 32 with a note for example “Symmetric”. On scene instruction 34 may say “Do not flip to card 3 until transport.”

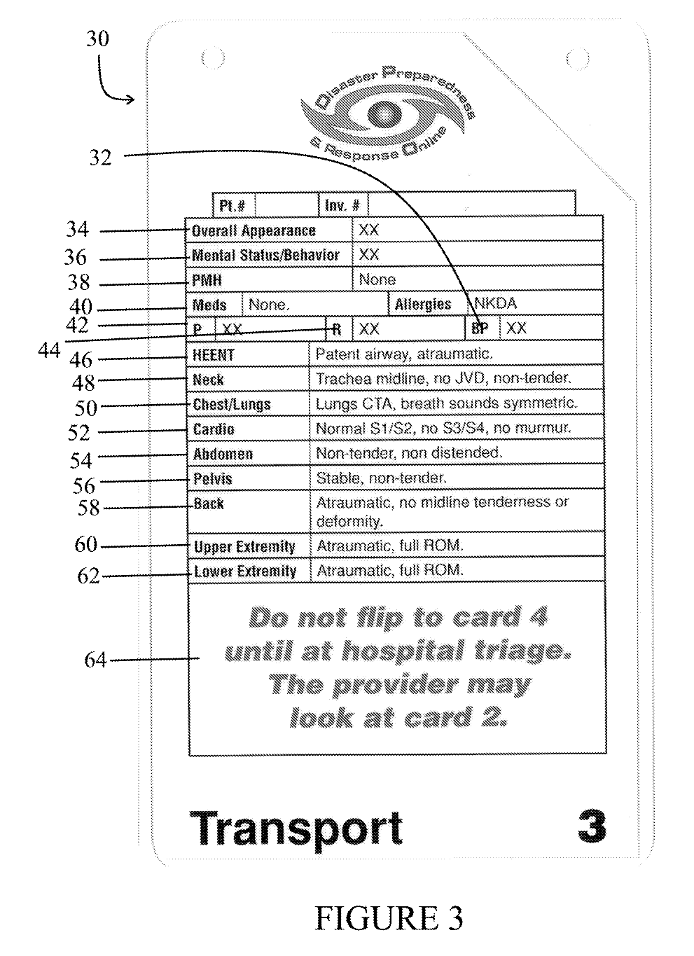

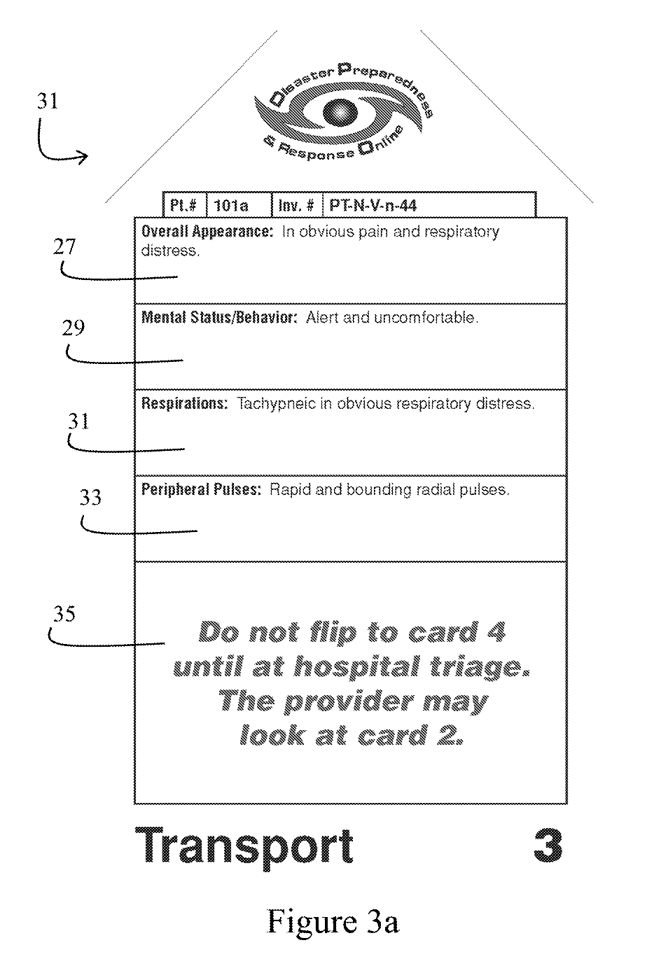

Referring to FIG. 3, as in one embodiment of the present invention, a third page 30 labeled Transport 3 is shown as the third page 30 with a BP box 32 for blood pressure. Also shown are overall appearance 34, mental status/behavior 36, PMH 38 for past medical history, Meds and allergies 40, P 42 for pulse, R 44 for respiration, HEENT 46 for head ears eyes neck throat, Neck 48, Chest/Lungs 50, Cardio 52, Abdomen 54, Pelvis 56, Back 58, Upper Extremity 60, Lower Extremities 62 and Transport instruction 64 that may say “Do not flip to card 4 until at hospital triage. The Provider may look at card 2.”

Referring to FIG. 3a, as in one embodiment of the present invention, a third page 31 labeled Transport 3 is shown as the third page with an overall appearance box 27. Shown are mental status/behavior box or field 29 with a note for example “alert”, Respirations box or filed 31 with a note of for example “even and unlabored” and Peripheral Pulses box 33 with a note for example “Symmetric”. Transports instruction 35 may say “Do not flip to card 4 until at hospital triage. The provider may look at card 2.”

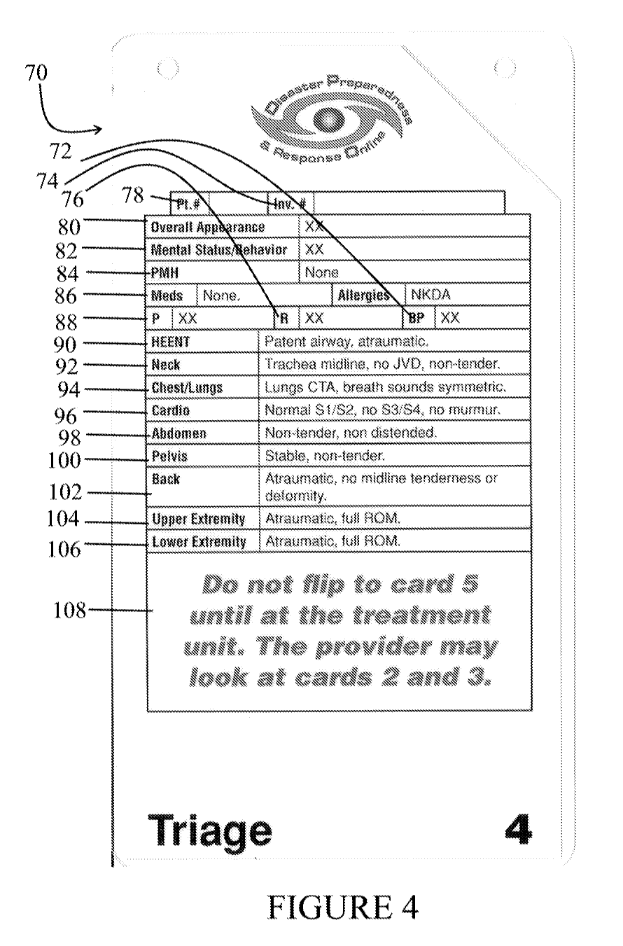

Referring to FIG. 4, as in one embodiment of the present invention, a fourth page 70 labeled Triage 4 is shown as the fourth page 70 with a BP box 72 for blood pressure. Shown are inventory descriptors, PT # 78 means “patient number” and INV # 74 means “inventory number”. Also shown are overall appearance 80, mental status/behavior 82, PMH 84, Meds and allergies 86, P 88, R 76, HEENT 90, Neck 92, Chest/Lungs 94, Cardio 96, Abdomen 98, Pelvis 100, Back 102, Upper Extremity 104, Lower Extremities 106 and triage instruction 108 that may say “Do not flip to card 5 until at the treatment unit. The Provider may look at cards 2 and 3.” Each set of review of systems on each card could be the same from the previous card or they could all be different or a combination of both different and the same it depends on if the victims condition is changing.

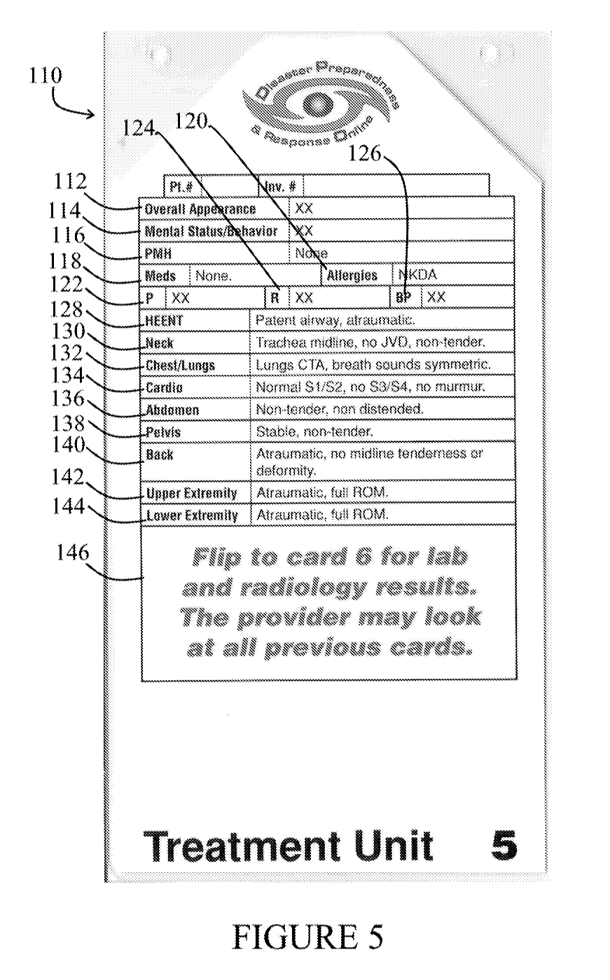

Referring to FIG. 5, as in one embodiment of the present invention, a fifth page 110 labeled Treatment Unit 5 is shown as the fifth page with a BP box 126 for blood pressure. Also shown are overall appearance 112, mental status/behavior 114, PMH 116, Meds 118 and allergies 120, P 122, R 124, HEENT 128, Neck 130, Chest/Lungs 132, Cardio 134, Abdomen 136, Pelvis 138, Back 140, Upper Extremity 142, Lower Extremities 144 and Treatment Unit instruction 146 that may say “Do not flip to card 6 for lab and radiology results. The Provider may look at all previous cards.”

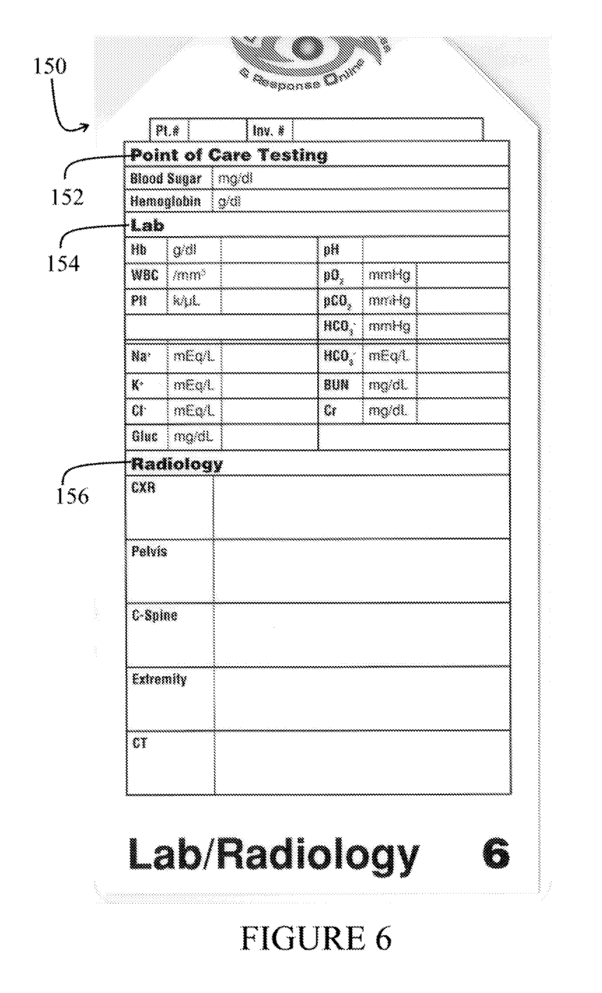

Referring to FIG. 6, as in one embodiment of the present invention, a sixth page 150 labeled Lab/Radiology 6 is shown as the sixth page with a point of care Testing Box 152. In the point of care box testing box 152 there is blood sugar and hemoglobin. Also shown is a Lab box 154 with Hb hemoglobin, WBC white cell count and Plt platelets. A Radiology box 156 is shown with CXR chest x-ray, Pelvis, C-spine, extremity and CT.

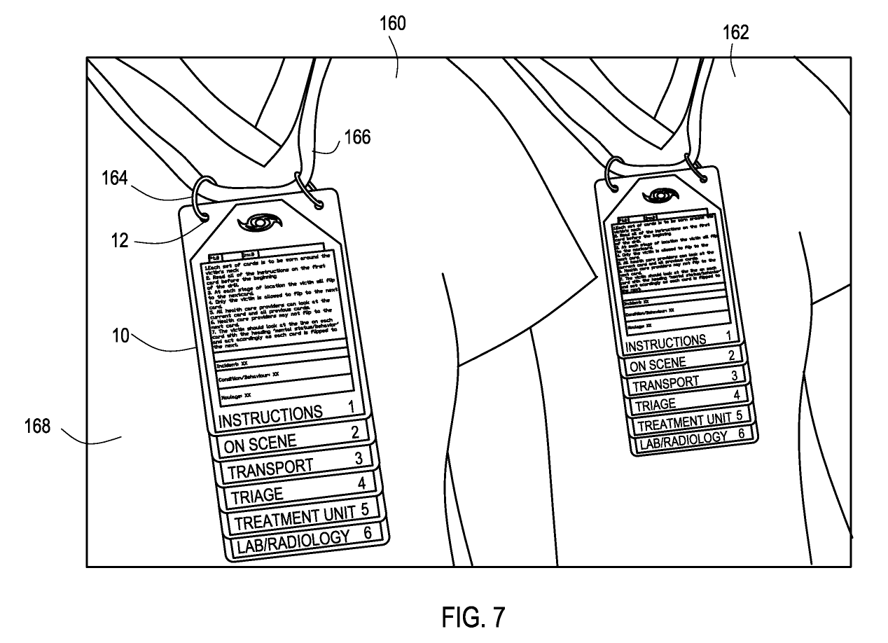

Referring to FIG. 7, as in one embodiment of the present invention, shown is a first victim 160 and a second victim 162. The disaster preparedness method 10 with connecting holes 12 has rings 164 through the connecting holes 12. A neck strap 166 goes around a victim's neck and allows the disaster preparedness method 10 to be displayed prominently on the victim's chest and mid section 168.

### Type of Disaster:

Nerve Agent: Organophosphate
Nerve Agent: Botulinum
Biological: Anthrax
Biological: Pandemic Influenza
Biological: Smallpox
Biological: Plague
Biological: Viral Hemorrhagic Fever
Blast: Enclosed Space
Blast: Enclosed Space With Structural Collapse
Blast: Open Environment
Blunt Trauma: Large Passenger Vehicle Accident
Penetrating Trauma: Multi-Victim Firearm Incident
Ionizing Radiation Exposure: Radiant Exposure
Ionizing Radiation Exposure: Contamination
Ionizing Radiation and Blast Force Exposure: Dirty Bomb Incident
   Select Card type:
Pre existing DPS card sets
Custom DPS card sets

### Number Of Victims: 25

50
75
100
150
200
250
300

### Would you like to RENT or PURCHASE your card sets?

1. To get details on Rent

click here

b 2. To get details on Purchase click here Purchase

Rent

### DPS Card Set Acuity Level: High Acuity: 40% Immediate, 30% Delayed, 30%

Minor and Walking Wounded

### Medium Acuity: 20% Immediate, 35% Delayed, 45% Minor and Walking

Wounded

Low acuity: 10% Immediate, 30% Delayed, 70% Minor and Walking Wounded
Special Needs DPS sets: Pediatric victims (5 victims)

Elderly victims (5 victims)

Pregnant victims (5 victims)

Burn victims (5 victims)

Psychiatric victims (5 victims)

Other (contact DPRO)

### Triage and Patient Tracking Tool: Yes

No

### Free Just-In-Time Training Manual: Yes

No

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A method comprising:
wearing a set of cards around a neck of a victim;
instructing the victim and health care provider on card 1;
displaying on scene information on card 2 after card 1 is flipped over;
displaying transport information on card 3 after card 2 is flipped over;
displaying triage information on card 4 after card 3 is flipped over:
displaying treatment unit information on card 5 after card 4 is flipped over; and
displaying lab/radiology information on card 6 after card 5 is flipped over.

2. The method of claim 1 wherein all cards a connected together to allow each card to be flipped over and not be seen.

3. The method of claim 1 wherein all cards are connected with two rings.

4. The method of claim 1 wherein card 1 is simple instructions to the victim and providers and an overall description of the victim's condition, behavior, and moulage card 2 is on scene: Description of the victim's on-scene status including mental status/behavior, peripheral pulses, respiratory effort, and obvious injuries card 3 is Transport: Updated and/or reassessment of the victim's status including mental status/behavior, peripheral pulses, respiratory effort, and obvious injuries card 4 is Hospital triage: Initial full set of vital signs, updated mental status/behavior, peripheral pulses, respiratory effort, and obvious injuries card 5 is Treatment unit: Updated vital signs, updated mental status/behavior, peripheral pulses, respiratory effort, and obvious injuries and card 6 is Lab and radiology results when appropriate and “clinical hint” regarding potential diagnostic studies and treatments as well as what may be harmful to the patient.
